(19) United States
(12) Patent Application Publication
(10) Pub. No.: US 2006/0119739 A1
(43) Pub. Date: Jun. 8, 2006

(54) Gamma correction apparatus and methods thereof

(76) Inventors: Il-kwon Chang, Gimpo-si (KR); Yong-weon Jeon, Suwon-si (KR)

Correspondence Address: HARNESS, DICKEY & PIERCE, P.L.C., P.O. BOX 8910, RESTON, VA, 20195, US

(21) Appl. No.: 11/291,977

(22) Filed: Dec. 2, 2005

(30) Foreign Application Priority Data
Dec. 3, 2004 (KR) 10-2004-0101141

(51) Int. Cl. H04N 9/64; G09G 5/02

(52) U.S. Cl. 348/650; 345/591

(57) ABSTRACT

A gamma correction apparatus and methods thereof. The gamma correction apparatus may include at least one switching unit and a digital-to-analog converter, for example a capacitor digital-to-analog converter. The switching unit may transfer a first voltage to the digital-to-analog converter in response to a control signal. The digital-to-analog converter may generate a plurality of linear lines based at least in part on the first voltage to approximate a non-linear curve by generating a voltage transmission characteristic curve. A received digital signal may be converted into an analog signal based on the generated voltage transmission characteristic curve.

### PRIORITY STATEMENT

This application claims the benefit of Korean Patent Application No. 10-2004-0101141, filed on Dec. 3, 2004, in the Korean Intellectual Property Office, the disclosure of which is incorporated herein in its entirety by reference.

### BACKGROUND OF THE INVENTION

1. Field of the Invention

Example embodiments of the present invention relate generally to a gamma correction apparatus and methods thereof, and more particularly to a gamma correction apparatus and methods for gamma correction by approximating a non-linear curve.

2. Description of the Related Art

Digital video displays, such as liquid crystal displays (LCDs) and plasma display panels (PDPs), may be used separately and/or in conjunction with conventional cathode ray tubes (CRTs). In conventional video displays, a gradation of an output signal with respect to an input signal may be non-linear such that each video display may have a distinct (e.g., unique) input/output (I/O) characteristic. The relationship between an input brightness of an input image signal (e.g., an RGB signal) and an output brightness of an output image signal of a display may be an example of a gamma characteristic.

FIG. 1 is a graph illustrating gamma characteristics of a conventional capacitor digital-to-analog converter (DAC) in a LCD panel. Referring to FIG. 1, the LCD panel may have a non-linear gamma characteristic curve 10. In a higher gray-level LCD system with a driver integrated circuit (IC) having a higher resolution (e.g., higher than 10 bits), the capacitor DAC (not shown) may include a higher number of capacitors and/or a higher level of capacitance as compared to a resistor DAC (R-DAC) including a higher number of resistors and/or a higher level of resistance. Referring to FIG. 1, in the capacitor DAC, a gamma characteristic curve 12 for input digital data may be a single, straight, linear curve.

Referring to FIG. 1, a middle portion A of the gamma characteristic curve 10 may include a higher number of gray codes. A range of voltages (e.g., as represented on the Y-Axis) corresponding to the respective gray codes may be narrow, which may indicate that a voltage potential difference between neighboring gray codes may be lower. 2 bits of resolution may be added to a 10-bit ADC and a mapping of gamma codes of the non-linear gamma characteristic curve to gamma codes of a linear gamma characteristic graph may be used to mitigate this problem. However, since the gamma characteristic curve 12 of the capacitor DAC may be linear, a gray code discontinuity or gray code jumping may occur, as shown in an exploded part B of FIG. 1. If the gray codes of a LCD panel are mapped to adjacent capacitor DAC levels, gray codes may not be capable of representation. Thus, erroneous gray codes may be displayed.

### SUMMARY OF THE INVENTION

An example embodiment of the present invention is directed to a gamma correction apparatus, including a first switching unit transferring one of a first gamma voltage and a second gamma voltage as a first voltage and selectively transferring a first gamma reference voltage between the first gamma voltage and the second gamma voltage as a second voltage, in response to at least one control signal and a digital-to-analog converter first dividing a voltage potential difference between the first voltage and the second voltage to generate a first plurality of linear lines with at least two of the first plurality of linear lines having different slopes, generating a voltage transmission characteristic curve based at least in part on the first plurality of linear lines and converting a received digital signal into an analog signal using the voltage transmission characteristic curve.

Another example embodiment of the present invention is directed to a method of gamma correction, including receiving, as a first voltage, one of a first gamma voltage and a second gamma voltage, receiving, as a second voltage, at least one first gamma reference voltage set between the first gamma voltage and the second gamma voltage, dividing a voltage potential difference between the first and second voltages to generate a first plurality of linear curves with at least two of the first plurality of linear curves having different slopes, generating a voltage transmission characteristic curve based at least in part on the first plurality of linear curves and converting a received digital signal into an analog signal using the generated voltage transmission characteristic curve.

Another example embodiment of the present invention is directed to a method of approximating a non-linear curve, including receiving the non-linear curve, generating a plurality of linear curves based on the received non-linear curve and combining the plurality of linear curves to approximate the non-linear curve.

### BRIEF DESCRIPTION OF THE DRAWINGS

The accompanying drawings are included to provide a further understanding of the invention, and are incorporated in and constitute a part of this specification. The drawings illustrate example embodiments of the present invention and, together with the description, serve to explain principles of the present invention.

FIG. 1 is a graph illustrating gamma characteristics of a conventional capacitor digital-to-analog converter (DAC) in a LCD panel.

FIG. 2 is a graph illustrating gamma characteristics of a capacitor DAC according to an example embodiment of the present invention.

FIG. 3 is a graph illustrating gamma characteristics of another capacitor DAC according to another example embodiment of the present invention.

FIG. 4 illustrates a gamma correction apparatus according to another example embodiment of the present invention.

FIG. 5 illustrates an arrangement of a switching unit and a capacitor DAC according to another example embodiment of the present invention

FIG. 6 illustrates a capacitor DAC according to another example embodiment of the present invention.

FIG. 7 is a timing diagram of an operation of a capacitor DAC according to another example embodiment of the present invention.

### DETAILED DESCRIPTION OF EXAMPLE EMBODIMENTS OF THE PRESENT INVENTION

Hereinafter, example embodiments of the present invention will be described in detail with reference to the accompanying drawings.

In the Figures, the same reference numerals are used to denote the same elements throughout the drawings.

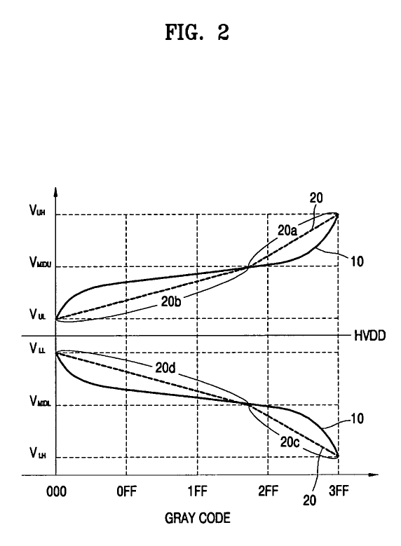

FIG. 2 is a graph illustrating gamma characteristics of a capacitor DAC according to an example embodiment of the present invention.

In the example embodiment of FIG. 2, each of first and second gamma voltages V_{UH} and V_{UL} and third and fourth gamma voltages V_{LH} and V_{LL} may be set based on a common voltage HVDD. In an example, the common voltage HVDD may correspond to half of a supply voltage V_{DD}. The first and second gamma voltages V_{UH} and V_{UL} may be higher (e.g., positive) than the common voltage HVDD and the third and fourth gamma voltages V_{LH} and V_{LL} may be lower (e.g., negative) than the common voltage HVDD due to a polarity inversion characteristic of a display system (e.g., a LCD display system including the first capacitor DAC).

In the example embodiment of FIG. 2, a middle voltage of the first and second gamma voltages V_{UH} and V_{UL} may be set to a first gamma reference voltage V_{MIDU}. A gamma characteristic curve 20 with a positive polarity may be formed by linear curves 20a and 20b having different slopes. The linear curve 20a may be formed between the first gamma voltage V_{UH} and the first gamma reference voltage V_{MIDU} and the linear curve 20b may be formed between the first gamma reference voltage V_{MIDU} and the second gamma voltage V_{UL}.

In the example embodiment of FIG. 2, a middle voltage of the third and fourth gamma voltages V_{LH} and V_{LL} may be set to a second gamma reference voltage V_{MIDL}. The gamma characteristic curve 20 with a negative polarity may be formed by linear curves 20c and 20d having different slopes, where the linear curve 20c may be formed between the third gamma voltage V_{LH} and the second gamma reference voltage V_{MIDL} and the linear curve 20d may be formed between the second gamma reference voltage V_{MIDL} and the fourth gamma voltage V_{LL}.

In the example embodiment of FIG. 2, a first voltage potential difference between the first gamma voltage V_{UH} and the second gamma voltage V_{UL} may equal a second voltage potential difference between the third gamma voltage V_{LH} and the fourth gamma voltage V_{LL}.

In another example embodiment of the present invention, referring to FIG. 2, the corrected gamma characteristic 20 may better approximate the gamma characteristic curve 10 as compared to the conventional gamma characteristic curve 12.

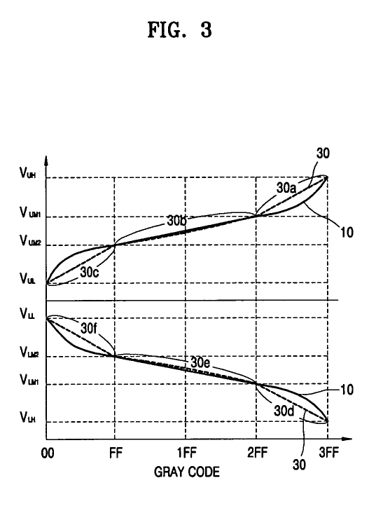

FIG. 3 is a graph illustrating gamma characteristics of another capacitor DAC according to another example embodiment of the present invention.

In the example embodiment of FIG. 3, the first and second gamma reference voltages V_{UM1} and V_{UM2} may each be set between the first and second gamma voltages V_{UH} and V_{UL} and the third and fourth gamma reference voltages V_{LM1} and V_{LM2} may each be set between the third and fourth gamma voltages V_{LH} and V_{LL}. A gamma characteristic curve 30 with a positive polarity may be formed by linear curves 30a, 30b, and 30c having different slopes, where the linear curve 30a may be formed between the first gamma voltage V_{UH} and the first gamma reference voltage V_{UM1}, the linear curve 30b may be formed between the first gamma reference voltage V_{UM1} and the second gamma reference voltage V_{UM2} and the linear curve 30c may be formed between the second gamma reference voltage V_{UM2} and the second gamma voltage V_{UL}. The third and fourth gamma reference voltages V_{LM1} and V_{LM2} may be set between the third gamma voltage V_{LH} and the fourth gamma voltage V_{LL}.

In the example embodiment of FIG. 3, a gamma characteristic curve 30 with a negative polarity may be formed by linear curves 30d, 30e, and 30f having different slopes, where the linear curve 30d may be formed between the third gamma voltage V_{LH} and the third gamma reference voltage V_{LM1}, the linear curve 30e may be formed between the third gamma reference voltage V_{LM1} and the fourth gamma reference voltage V_{LM2} and the linear curve 30f may be formed between the fourth gamma reference voltage V_{LM2} and the fourth gamma voltage V_{LL}.

In another example embodiment of the present invention, referring to FIG. 3, the corrected gamma characteristic 30 may better approximate the gamma characteristic curve 10 as compared to the conventional gamma characteristic curve 12.

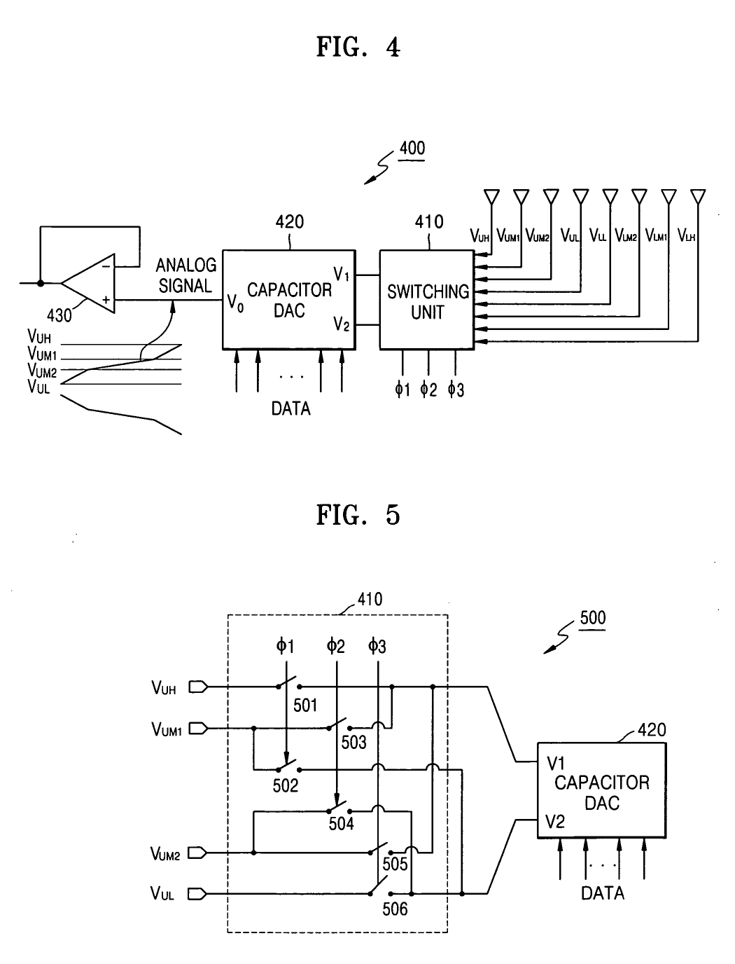

FIG. 4 illustrates a gamma correction apparatus 400 according to another example embodiment of the present invention.

In the example embodiment of FIG. 4, the gamma correction apparatus 400 (e.g., included within a LCD display system) may implement the corrected gamma characteristic curve 30 of FIG. 3.

In the example embodiment of FIG. 4, the gamma correction apparatus 400 may include a switching unit 410, a capacitor DAC 420 and an amplifier 430. The switching unit 410 may selectively transfer the first through fourth gamma voltages V_{UH}, V_{UL}, V_{LH}, and V_{LL} and the first through fourth gamma reference voltages V_{UM1}, V_{UM2}, V_{LM1}, and V_{LM2} to a capacitor DAC 420 in response to first through third control signals Φ1, Φ2, and Φ3. The capacitor DAC 420 may convert digital image data DATA into an analog signal in response to the first through fourth gamma voltages V_{UH}, V_{UL}, V_{LH}, and V_{LL} and the first through fourth gamma reference voltages V_{UM1}, V_{UM2}, V_{LM1}, and V_{LM2} received from the switching unit 410. The amplifier 430 may amplify the converted analog signal received from the capacitor DAC 420.

FIG. 5 illustrates an arrangement 500 of the switching unit 410 and the capacitor DAC 420 of FIG. 4 according to another example embodiment of the present invention

In the example embodiment of FIG. 5, the switching unit 410 may include first and second switches 501 and 502 which may transfer the first gamma voltage V_{UH} and the first gamma reference voltage V_{UM1}, respectively, as first and second voltages V1 and V2, respectively, to the capacitor DAC 420 in response to the first control signal Φ1. The switching unit 410 may further include third and fourth switches 503 and 504 which may transfer the first gamma reference voltage V_{UM1} and the second gamma reference voltage V_{UM2}, respectively, as first and second voltages V1 and V2, respectively, to the capacitor DAC 420 in response to the second control signal Φ2. The switching unit 410 may further include fifth and sixth switches 505 and 506 which may transfer the second gamma reference voltage V_{UM2} and the second gamma voltage V_{UL}, respectively, as first and second voltages V1 and V2, respectively, to the capacitor DAC 420 in response to the third control signal Φ3.

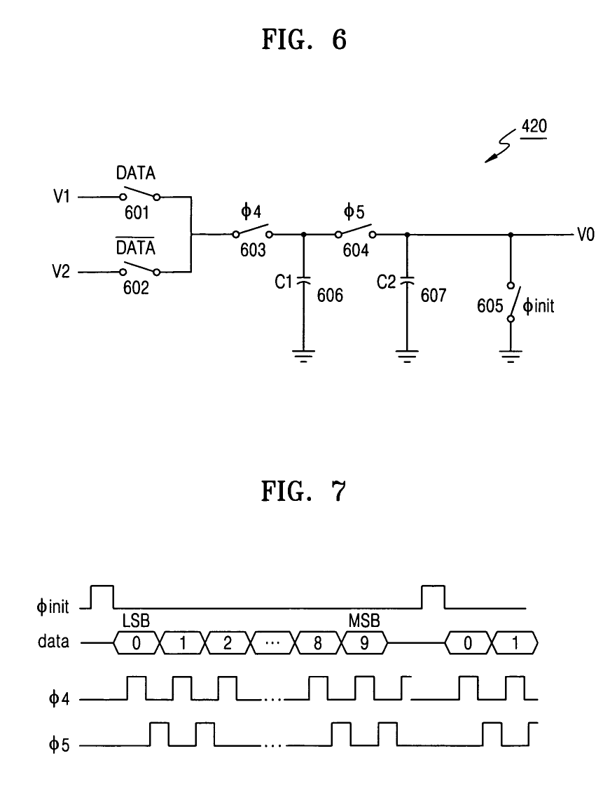

FIG. 6 illustrates the capacitor DAC 420 of FIG. 4 according to another example embodiment of the present invention.

In the example embodiment of FIG. 6, the capacitor DAC 420 may include first through fifth switches 601/602/603/604/605 and first and second capacitors 606 and 607. The first and second switches 601 and 602 may be switched in response to digital image data DATA, the third and fourth switches 603 and 604 may be switched in response to fourth and fifth control signals Φ4 and Φ5 and the fifth switch 605 may be switched in response to the first control signal Φ1 to charge the first and second capacitors 606 and 607. In an example, the first capacitor 606 and the second capacitor 607 may have a capacitance C. In a further example, a charge voltage of the second capacitor 607 may be set to an output voltage V0 of the capacitor DAC 420.

FIG. 7 is a timing diagram of an operation of the capacitor DAC 420 according to another example embodiment of the present invention.

In the example operation of FIG. 7, it may be assumed that the digital image data DATA may be received having 10 bits including a bit logic portion of “11001011”. It may be further assumed, within the example operation of FIG. 7, that a first voltage level may correspond to a logic “1” and the second voltage level may correspond to a logic “0”.

In the example operation of FIG. 7, if an initial control signal Φinit is set to the first voltage level (e.g., a higher voltage level), an output voltage V0 may be set to the second voltage level (e.g., a lower voltage level, 0 V, etc.). In this example, the initial control signal Φinit may transition to the second logic level (e.g., a lower logic level) when the digital image signal DATA is received.

In the example operation of FIG. 7, a least significant bit (LSB) of the digital image signal DATA may be a logic “1” and the first switch 601 may be turned on. The fourth control signal Φ4 may transition to the first voltage level to turn on the third switch 603 such that the first capacitor 606 may be charged to the first voltage V1. If the fifth control signal Φ5 transitions to the first voltage level (e.g., a higher voltage level, logic “1”, etc.) and the fourth control signal Φ4 transitions to the second voltage level (e.g., a lower voltage level, logic “0”, etc.) the first and second capacitors 606 and 607 may be charged to a voltage represented by Expression 1 which may be given as

$$\frac{V 1}{2} \qquad Expression 1$$

In the example operation of FIG. 7, a second bit (e.g., following the least significant bit in the digital image signal DATA or the second most least significant bit) may be set to the logic “1” and the first switch 601 may be turned on such that the fourth control signal Φ4 may transition to the first voltage level (e.g., a higher voltage level, logic “1”, etc.). The third switch 603 may be turned on and the first capacitor 606 may be charged to the first voltage V1. If the fifth control signal Φ5 transitions to the first voltage level (e.g., a higher voltage level, logic “1”, etc.) and the fourth control signal Φ4 transitions to the second voltage level (e.g., a lower voltage level, logic “0”, etc.), the first and second capacitors 606 and 607 may be charged to a voltage represented by Expression 2 which may be given as

$$( V 1 + \frac{V 1}{2} ) / 2 = V 1 \times \frac{3}{4} \qquad Expression 2$$

In the example operation of FIG. 7, a third bit (e.g., following the second bit in the digital image signal DATA) may be set to the logic “0” and the first and second capacitors 606 and 607 may be charged to a voltage represented by Expression 3 which may be given as

$$\frac{( V 1 \times \frac{3}{4} + V 2 )}{2} \qquad Expression 3$$

In the example embodiment of FIG. 7, the fourth through tenth LSBs of the digital image signal DATA may be handled similar to the above-described operation with respect to the first three LSBs, described with respect to Equations 1-3, such that the output voltage V0 of the capacitor DAC 420 may be obtained. The capacitor DAC 420 may divide (e.g., equally divide) a voltage potential difference between the first voltage V1 and the second voltage V2. The first and second voltages V1 and V2 may be used to generate a voltage transmission characteristic of, for example, a LCD panel.

In another example embodiment of the present invention, referring to FIGS. 3 and 5, a voltage potential difference between the first gamma voltage V_{UH} and the first gamma reference voltage V_{UM1} may be transferred as the first and second voltages V1 and V2, respectively, of the capacitor DAC 420 in response to the first control signal Φ1 to generate the linear curve 30a illustrated in FIG. 3.

In another example embodiment of the present invention, referring to FIGS. 3 and 5, a voltage potential difference between the first gamma reference voltage V_{UM1} and the second gamma reference voltage V_{UM2} may be transferred as the first and second voltages V1 and V2, respectively, of the capacitor DAC 420 in response to the second control signal Φ2 to form the linear curve 30b illustrated in FIG. 3.

In another example embodiment of the present invention, referring to FIGS. 3 and 5, a voltage potential difference between the second gamma reference voltage V_{UM1} and the second gamma voltage V_{UL} may be transferred as the first and second voltages V1 and V2, respectively, of the capacitor DAC 420 in response to the third control signal Φ3 to form the linear curve 30c illustrated in FIG. 3.

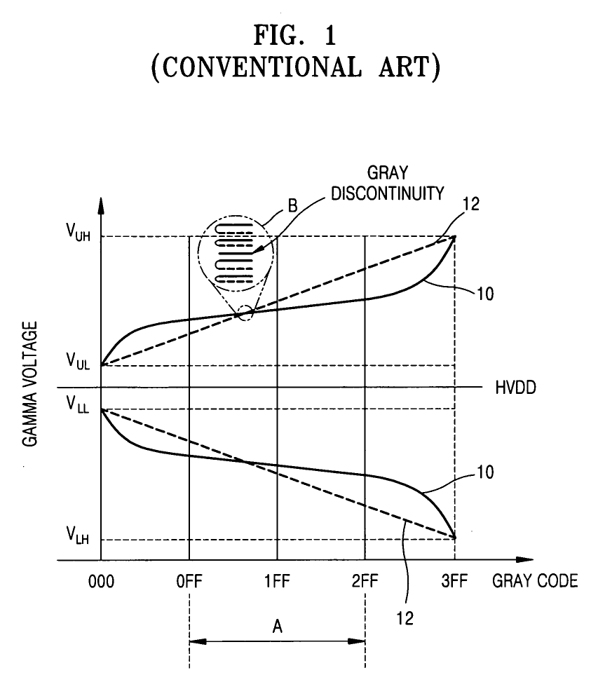

In another example embodiment of the present invention, the linear curves 30a, 30b and 30c may combine to form the gamma characteristic curve 30 having a positive polarity. The gamma characteristic curve 30 may approximate the gamma characteristic curve 10 as compared to the conventional gamma characteristic curve 12 of FIG. 1.

In another example embodiment of the present invention, the gamma correction apparatus 400 of FIG. 4 may further include a second switching unit (not shown) which may receive a third or fourth negative gamma voltage which may be lower than the common voltage HVDD. The second switching unit may selectively transfer the third or fourth gamma voltage and a second gamma reference voltage set between the third gamma voltage and the fourth gamma voltage. The capacitor DAC 420 may divide (e.g., equally divide) a voltage potential difference between the third gamma voltage and the fourth gamma voltage transferred from the second switching unit using the second gamma reference voltage as an inflection point to generate linear curves (e.g., which may be represented as straight lines) having different slopes to generate a negative gamma characteristic curve N30.

In another example embodiment of the present invention, by setting a first gamma reference voltage between positive gamma voltages and a second gamma reference voltage between negative gamma voltages, linear curves having different slopes may be generated (e.g., by using the gamma reference voltages as inflection points). The generated linear curves may be used to form a gamma characteristic curve which may approximate a non-linear gamma characteristic curve of, for example, a LCD panel.

Example embodiments of the present invention being thus described, it will be obvious that the same may be varied in many ways. For example, it is understood that the above-described first and second voltage levels may correspond to a higher level (e.g., logic “1”) and a lower logic level (e.g., logic “0”), respectively, in an example embodiment of the present invention. Alternatively, the first and second voltage levels may correspond to the lower logic level (e.g., logic “0”) and the higher logic level (e.g., logic “1”), respectively, in other example embodiments of the present invention.

Further, while above-described example embodiments are directed to approximating a non-linear gamma characteristic curve in an LCD panel, it will be readily apparent that other example embodiments of the present invention may be directed to approximating other non-linear curves (e.g., other than gamma characteristic curves) for devices other than LCD panels. For example, other example embodiments of the present invention may be directed to a plurality of linear curves used to approximate a non-linear curve in any device.

Further, while above-described example embodiments of the present invention are directed to two gamma reference voltages, it is understood that other example embodiments of the present invention may include any number (e.g., two or more) of gamma reference voltages, for example set between the positive gamma voltages and/or between the negative gamma voltages.

Such variations are not to be regarded as departure from the spirit and scope of example embodiments of the present invention, and all such modifications as would be obvious to one skilled in the art are intended to be included within the scope of the following claims.

What is claimed is:

1. A gamma correction apparatus, comprising:
a first switching unit transferring one of a first gamma voltage and a second gamma voltage as a first voltage and selectively transferring a first gamma reference voltage between the first gamma voltage and the second gamma voltage as a second voltage, in response to at least one control signal; and
a digital-to-analog converter first dividing a voltage potential difference between the first voltage and the second voltage to generate a first plurality of linear lines with at least two of the first plurality of linear lines having different slopes, generating a voltage transmission characteristic curve based at least in part on the first plurality of linear lines and converting a received digital signal into an analog signal using the voltage transmission characteristic curve.

2. The gamma correction apparatus of claim 1, wherein the digital-to-analog converted divides the voltage potential difference equally.

3. The gamma correction apparatus of claim 1, wherein the received digital signal is a digital image signal.

4. The gamma correction apparatus of claim 1, wherein the digital-to-analog converter is a switched-capacitor digital-to-analog converter which includes a plurality of switches and a plurality of capacitors, the digital-to-analog converter receiving the first and second voltages from the switching unit and controlling capacitances of the plurality of capacitors based at least in part on the received first and second voltages.

5. The gamma correction apparatus of claim 1, wherein the digital-to-analog converter includes:
a first gamma switching unit receiving the first voltage in response to the digital signal;
a second gamma switching unit receiving the second voltage in response to the digital signal;
a third gamma switching unit transferring one of the first and second voltages to a first capacitor in response to a first control signal; and
a fourth gamma switching unit transferring charges stored in the first capacitor to a second capacitor in response to a second control signal.

6. The gamma correction apparatus of claim 5, wherein the digital-to-analog converter further includes a fifth gamma switching unit discharging the second capacitor to a ground voltage in response to an initial control signal.

7. The gamma correction apparatus of claim 5, wherein the first capacitor and the second capacitor have the same capacitance.

8. The gamma correction apparatus of claim 1, further comprising:
a second switching unit receiving one of a third and a fourth gamma voltage as a third voltage, each of the first and second gamma voltages being higher than a common voltage and each of the third and fourth gamma voltages being lower than the common voltage, and selectively transferring the third voltage and a fourth voltage, the fourth voltage being a second gamma reference voltage set between the third gamma voltage and the fourth gamma voltage in response to the at least one control signal;
wherein the digital-to-analog converter second divides a voltage potential difference the third and fourth voltages to generate a second plurality of linear curves with at least two of the second plurality of linear curves having different slopes, generates voltage transmission characteristic curve based on the first and second plurality of linear curves and converts the received digital signal into the analog signal using the voltage transmission characteristic curve.

9. The gamma correction apparatus of claim 8, wherein the digital signal is a digital image signal.

10. The gamma correction apparatus of claim 8, wherein the first and second divisions are equal divisions.

11. The gamma correction apparatus of claim 8, wherein the digital-to-analog converter is a switched-capacitor digital-to-analog converter which includes a plurality of switches and a plurality of capacitors, the digital-to-analog converter receiving the first, second, third and fourth voltages from the switching unit and controlling capacitances of the plurality of capacitors based on at least one of the received first, second, third and fourth voltages.

12. The gamma correction apparatus of claim 11, wherein the digital-to-analog converter includes:
a first gamma switching unit receiving the first voltage in response to the digital signal;
a second gamma switching unit receiving the second voltage in response to the digital signal;
a third gamma switching unit transferring one of the first and second voltages to a first capacitor in response to a first control signal; and
a fourth gamma switching unit transferring charges stored in the first capacitor to a second capacitor in response to a second control signal.

13. The gamma correction apparatus of claim 12, wherein the digital-to-analog converter further includes a fifth gamma switching unit discharging the second capacitor to a ground voltage in response to an initial control signal.

14. The gamma correction apparatus of claim 12, wherein the first capacitor and the second capacitor have the same capacitance.

15. The gamma correction apparatus of claim 8, wherein the voltage potential difference between the first gamma voltage and the second gamma voltage equals the voltage potential difference between the third gamma voltage and the fourth gamma voltage.

16. A method of gamma correction, comprising:
receiving, as a first voltage, one of a first gamma voltage and a second gamma voltage;
receiving, as a second voltage, at least one first gamma reference voltage set between the first gamma voltage and the second gamma voltage;
dividing a voltage potential difference between the first and second voltages to generate a first plurality of linear curves with at least two of the first plurality of linear curves having different slopes;
generating a voltage transmission characteristic curve based at least in part on the first plurality of linear curves; and
converting a received digital signal into an analog signal using the generated voltage transmission characteristic curve.

17. The method of claim 16, wherein the second voltage is used as an inflection point during the dividing.

18. The method of claim 16, wherein the first and second gamma voltages are higher than a common voltage.

19. The gamma correction method of claim 18, wherein the common voltage is half of a supply voltage.

20. The gamma correction method of claim 16, further comprising:
receiving, as a third voltage, one of a third gamma voltage and a fourth gamma voltage, each of the third and fourth gamma voltages lower than a common voltage;
receiving, as a fourth voltage, at least one second gamma reference voltage set between the third gamma voltage and the fourth gamma voltage;
dividing a voltage potential difference between the third and fourth voltages to generate a second plurality of linear curves with at least two of the second plurality of linear curves having different slopes; and
generating the voltage transmission characteristic curve based at least in part on the second plurality of linear curves,
wherein the first and second voltages are higher than the common voltage.

21. The gamma correction method of claim 20, wherein a voltage potential difference between the first gamma voltage and the second gamma voltage is the same as a voltage potential difference between the third gamma voltage and the fourth gamma voltage.

22. A method of approximating a non-linear curve, comprising:
receiving the non-linear curve;
generating a plurality of linear curves based on the received non-linear curve; and
combining the plurality of linear curves to approximate the non-linear curve.

23. The method of claim 22, wherein the received non-linear curve is an analog signal and the combined plurality of linear curves is a digital signal.

24. A method of performing gamma correction with the gamma correction apparatus of claim 1.

25. A method of approximating a non-linear curve with the gamma correction apparatus of claim 1.
